(19) United States
(12) Patent Application Publication
(10) Pub. No.: US 2024/0249611 A1
(43) Pub. Date: Jul. 25, 2024

(54) INFORMATION PROCESSING DEVICE

(71) Applicant: TOYOTA JIDOSHA KABUSHIKI KAISHA, Toyota-shi (JP)

(72) Inventor: Yuki NAKAGAWA, Toyota-shi (JP)

(73) Assignee: TOYOTA JIDOSHA KABUSHIKI KAISHA, Toyota-shi (JP)

(21) Appl. No.: 18/493,209

(22) Filed: Oct. 24, 2023

(30) Foreign Application Priority Data
Jan. 20, 2023 (JP) 2023-007636

(51) Int. Cl. G08B 21/24

(52) U.S. Cl. CPC G08B 21/24

(57) ABSTRACT

The information processing device notifies the mobile terminal of the window when one or more conditions including at least a first condition that the degree of opening of the window is greater than or equal to a first threshold value are satisfied while the vehicle is stopped.

### CROSS-REFERENCE TO RELATED APPLICATION

This application claims priority to Japanese Patent Application No. 2023-007636 filed on Jan. 20, 2023, incorporated herein by reference in its entirety.

### BACKGROUND

### 1. Technical Field

The present disclosure relates to an information processing device.

### 2. Description of Related Art

Conventionally, there is known a technology for notifying a user of forgotten operations of a vehicle. For example, Japanese Unexamined Patent Application Publication No. 2006-235823 (JP 2006-235823 A) discloses a technology for notifying a mobile terminal owned by a vehicle user regarding a forgotten operation, only when in a state in which the vehicle user is moving away from the vehicle after a predetermined amount of time has elapsed since the vehicle was parked.

### SUMMARY

There is room for improvement in the technology for notification of such forgotten operations of the vehicle.

An object of the present disclosure, which has been made in view of such circumstances, is to improve technology for notifying a user of forgotten operations of a vehicle.

An information processing device according to an embodiment of the present disclosure includes
a communication unit that communicates with a mobile terminal owned by a user of a vehicle, and
a control unit that, based on a vehicle state including at least an opening degree of a window of the vehicle, when the vehicle is stopped, performs notification to the mobile terminal regarding the window.
The control unit performs the notification to the mobile terminal when one or more conditions, including at least a first condition that the opening degree of the window is no less than a first threshold value, are satisfied.

According to one embodiment of the present disclosure, a technology for notification of a forgotten operation of a vehicle is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a schematic configuration of a system according to an embodiment of the present disclosure;

FIG. 2 is a block diagram showing a schematic configuration of the vehicle;

FIG. 3 is a block diagram showing a schematic configuration of a mobile terminal;

FIG. 4 is a block diagram showing a schematic configuration of an information processing device;

FIG. 5 is a flowchart showing the operation of the information processing device; and

FIG. 6 is a configuration diagram showing an example of the operation of the mobile terminal.

### DETAILED DESCRIPTION OF EMBODIMENTS

Hereinafter, an embodiment of the present disclosure will be described.

### Outline of Embodiment

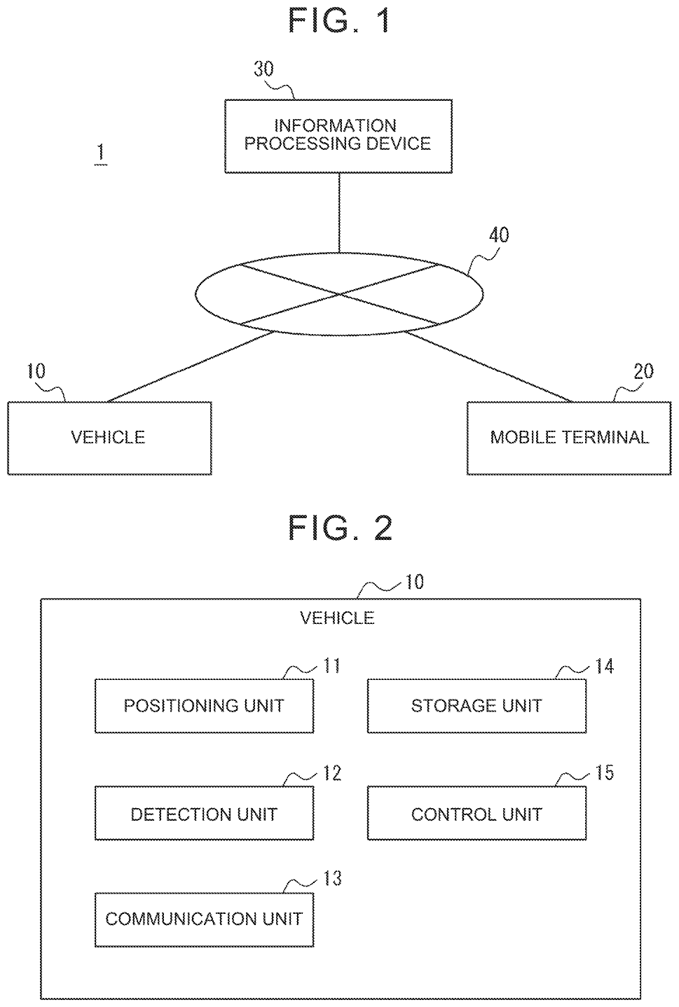

The outline of a system 1 according to an embodiment of the present disclosure will be described with reference to FIG. 1. The system 1 includes a vehicle 10, a mobile terminal 20 and an information processing device 30. The information processing device 30 is communicatively connected to each of the vehicle 10 and the mobile terminal 20 via a network 40 including, for example, a mobile communication network and the Internet.

The vehicle 10 is, for example, an automobile, but is not limited to this, and may be any vehicle. Automobiles include, but are not limited to, Battery Electric Vehicles (BEV), Hybrid Electric Vehicles (HEV), Plug-in Hybrid Electric Vehicles (PHEV), Fuel Cell Electric Vehicles (FCEV), and the like. The number of vehicles 10 provided in the system 1 may be arbitrarily determined.

In this embodiment, the vehicle 10 can acquire the vehicle state of the own vehicle, such as the opening degree of each window. Further, the vehicle 10 can transmit the acquired information indicating the vehicle state to the information processing device 30.

The mobile terminal 20 is, for example, a mobile computer such as a smart phone or a tablet terminal. In this embodiment, the mobile terminal 20 is carried and possessed by a user of the vehicle 10.

The information processing device 30 includes one or more computers that can communicate with each other. In this embodiment, the information processing device 30 can acquire the vehicle state of the vehicle 10 based on information received from the vehicle 10. The information processing device 30 can also notify the mobile terminal 20 of the windows of the vehicle 10 based on the acquired vehicle state. The notification regarding the window is, for example, a notification that informs the user that the window has been forgotten to be closed, but is not limited to this example.

First, the outline of the present embodiment will be described, and the details will be described later. When the vehicle 10 is stopped, the information processing device 30 notifies the mobile terminal 20 of the windows based on the vehicle state including at least the opening degree of the windows of the vehicle 10. Here, when one or more conditions including at least the first condition that the degree of opening of the window is equal to or greater than the first threshold are satisfied, the information processing device 30 notifies the mobile terminal 20 of the window.

Conventionally, when a user of a vehicle leaves the vehicle with the window open, there has been a technique of notifying the user's smartphone or the like that the window is open. However, the user of the vehicle may intentionally leave the vehicle with the windows open, for example for ventilation purposes. In the related art described above, even in such a case, a notification is sent to the user's smartphone or the like, which may be troublesome for the user.

By the way, when the user intentionally leaves the window open, it is normal to make the opening of the window relatively small, for example, from the viewpoint of crime prevention. In other words, when the degree of opening of the window is relatively small, there is a high probability that the user intentionally left the window open. According to the present embodiment, when the degree of opening of the window is equal to or greater than the first threshold, the mobile terminal 20 is notified of the window, and when the degree of opening is less than the first threshold, no notification is made. For this reason, when there is a high probability that the user intentionally keeps the window open, the notification regarding the window is not performed. In this way, the technique of notifying the user of forgetting to operate the vehicle 10 is improved in terms of reducing the annoyance of notification.

Next, each configuration of the system 1 will be described in detail.

### Configuration of Vehicle

As shown in FIG. 2, vehicle 10 includes positioning unit 11, detection unit 12, communication unit 13, storage unit 14 and control unit 15.

The positioning unit 11 includes one or more devices that acquire position information of the vehicle 10. Specifically, the positioning unit 11 includes, for example, a receiver compatible with the Global Positioning System (GPS), but is not limited to this and may include a receiver compatible with any satellite positioning system.

The detection unit 12 includes one or more sensors that detect the vehicle state including the state of each part of the vehicle 10. The vehicle state includes, for example, drive unit state, suspension state, running state (speed, selector lever position, steering angle, etc.), power supply voltage, vehicle 10 stopped, light ON/OFF state (including the states of high, low, hazard lamp, interior lamps, etc.), window opening/closing state (including degree of opening), seat belt wearing state, door state (open/closed, locked, etc.), surrounding state of the vehicle 10 (outside temperature, rainfall, snowfall state, etc.) of the vehicle 10 and the time at which the state occurred. Information indicating the vehicle state detected by the detection unit 12 can be transmitted and received via an in-vehicle network such as a Controller Area Network (CAN).

Communication unit 13 includes one or more communication interfaces that connect to network 40. The communication interface corresponds to mobile communication standards such as 4th Generation (4G) or 5th Generation (5G), or short-range communication standards such as wireless LAN, Wi-Fi (registered trademark), or Bluetooth (registered trademark). However, it is not limited to these. In this embodiment, the vehicle 10 communicates with the information processing device 30 or the mobile terminal 20 via the communication unit 13 and the network 40.

The storage unit 14 includes one or more memories. The memories are, for example, a semiconductor memory, a magnetic memory, or an optical memory, but are not limited to these memories. Each memory included in the storage unit 14 may function as, for example, a main storage device, an auxiliary storage device, or a cache memory. The storage unit 14 stores any information to be used for the operation of the vehicle 10. For example, the storage unit 14 may store system programs, application programs, databases, embedded software, and the like. The information stored in the storage unit 14 may be updateable with information acquired from the network 40 via the communication unit 13, for example.

The control unit 15 includes one or more processors, one or more programmable circuits, one or more dedicated circuits, or a combination of these. The processor is, but not limited to, a general-purpose processor such as a Central Processing Unit (CPU) or a Graphics Processing Unit (GPU), or a dedicated processor specialized for specific processing. The programmable circuit is, for example, a Field-Programmable Gate Array (FPGA), but is not limited to this. The dedicated circuit is, for example, an Application Specific Integrated Circuit (ASIC), but is not limited to this. The control unit 15 controls the overall operation of the vehicle 10.

### Configuration of Mobile Terminal

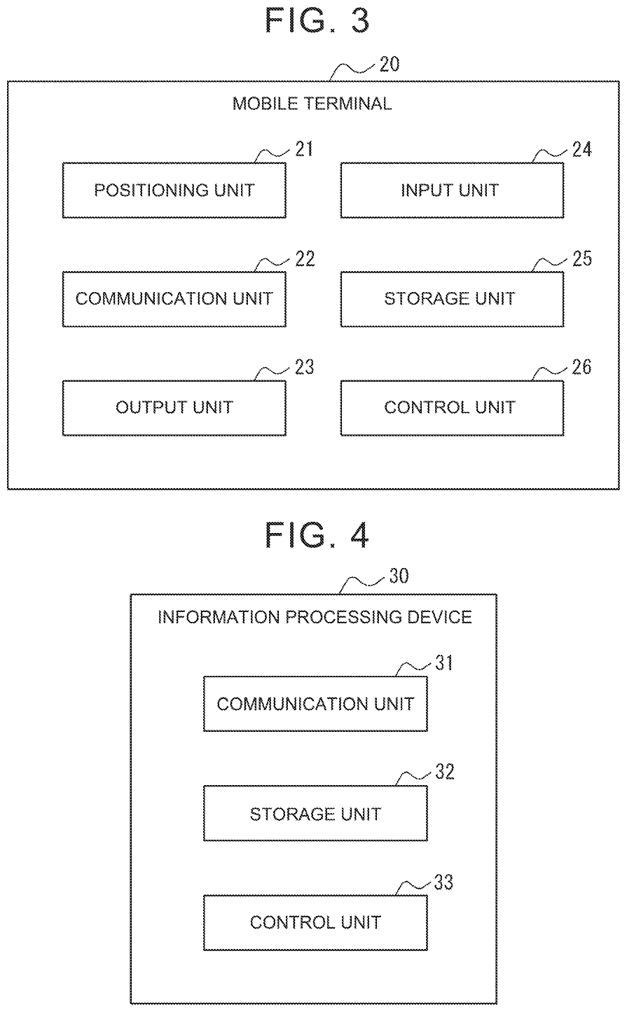

As shown in FIG. 3, mobile terminal 20 includes positioning unit 21, communication unit 22, output unit 23, input unit 24, storage unit 25 and control unit 26.

Positioning unit 21 includes one or more devices that acquire position information of mobile terminal 20. Specifically, the positioning unit 21 includes, for example, a receiver compatible with GPS, but is not limited to this, and may include a receiver compatible with any satellite positioning system.

Communication unit 22 includes one or more communication interfaces that connect to network 40. The communication interface corresponds to, for example, a mobile communication standard or a short-range communication standard, but is not limited to these, and may correspond to any communication standard. In this embodiment, the mobile terminal 20 communicates with the information processing device 30 or the vehicle 10 via the communication unit 22 and the network 40.

The output unit 23 includes one or more output devices that output information. The output unit 23 is, for example, a display device such as the display of the mobile terminal 20, or a speaker that outputs information by sound, but is not limited thereto. Alternatively, the output unit 23 may include an interface for connecting an external output device.

The input unit 24 is a device that receives a user's operation input, and includes, but is not limited to, physical keys, capacitance keys, a touch panel, a touch screen arranged on a display device, a microphone, and the like. Alternatively, the input unit 24 may include an interface for connecting an external input device. The touch panel accepts operation inputs such as user tap, double tap, long press, scroll, drag, flick, swipe, pinch, and rotate.

The storage unit 25 includes one or more memories. For example, each memory included in the storage unit 25 may function as a main storage device, an auxiliary storage device or a cache memory. The storage unit 25 stores arbitrary information used for the operation of the mobile terminal 20. For example, the storage unit 25 may store system programs, application programs, databases, embedded software, and the like. The information stored in the storage unit 25 may be updateable with information acquired from the network 40 via the communication unit 22, for example.

Control unit 26 includes one or more processors, one or more programmable circuits, one or more dedicated circuits, or combinations thereof. The control unit 26 controls the operation of the mobile terminal 20 as a whole.

### Configuration of Information Processing Device

As shown in FIG. 4, the information processing device 30 includes a communication unit 31, a storage section 32 and a control unit 33.

The communication unit 31 includes one or more communication interfaces connected to the network 40. In this embodiment, the information processing device 30 is, for example, a server or the like on the network 40 and communicates with the vehicle 10 or the mobile terminal 20 via the communication unit 31 and the network 40.

The storage unit 32 includes one or more memories. For example, each memory included in the storage unit 25 may function as a main storage device, an auxiliary storage device or a cache memory. The storage unit 25 stores arbitrary information used for the operation of the information processing device 30. For example, the storage unit 32 may store system programs, application programs, databases, embedded software, and the like. The information stored in the storage unit 32 may be updatable with information received from the network 40 via the communication unit 31, for example.

The control unit 33 includes one or more processors, one or more programmable circuits, one or more dedicated circuits, or a combination of these. The control unit 33 controls the operation of the information processing device 30 as a whole.

### Operation Flow of Information Processing Device

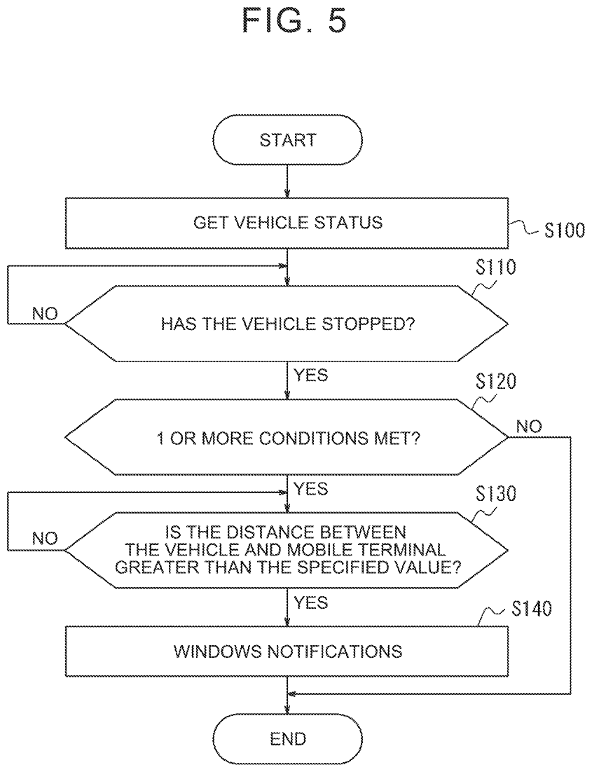

The operation of the information processing device 30 according to this embodiment will be described with reference to FIG. 5.

### S100

The control unit 33 of the information processing device 30 acquires the vehicle state of the vehicle 10 from the vehicle 10 via the network 40.

From the vehicle 10, information indicating the vehicle state including the state of each part of the vehicle 10 is periodically transmitted to the information processing device 30, for example. Based on the information received from the vehicle 10, the control unit 33 of the information processing device 30 acquires an event representing the type of the state of the vehicle and the time of occurrence of the event, for example, when the state of the vehicle changes. Further, the control unit 33 acquires the current position of the vehicle 10 acquired by the positioning unit 11 of the vehicle 10 at predetermined intervals or for each predetermined amount of movement.

### S110

The control unit 33 determines whether the vehicle 10 has stopped. If it is determined that the vehicle 10 has stopped (S110—Yes), the process proceeds to S120. On the other hand, if it is determined that the vehicle 10 is not stopped (S110—No), the process repeats S110.

Specifically, the control unit 33 acquires the stop event of the vehicle 10 and its time from among the vehicle states acquired in S100. The stop of the vehicle 10 may be obtained, for example, when the position of the select lever is changed to the “P (parking)” position.

### S120

Based on the vehicle state acquired in S100, the control unit 33 determines whether one or more conditions for notifying the mobile terminal 20 of the window are satisfied. If it is determined that the one or more conditions are satisfied (S120—Yes), the process proceeds to S130. On the other hand, if it is determined that at least one condition is not met (S120—No), the process ends.

In the present embodiment, the one or more conditions for performing window-related notification include at least the first condition described later, but are not limited to this example. For example, the one or more conditions may further include, in addition to the first condition, at least one of second to fifth conditions described later. Alternatively, the one or more conditions may include at least one of first to fifth conditions described later.

First, when the user of the vehicle 10 opens and closes the window and the window is opened, the control unit 33 acquires the event, the time, and the degree of opening. Also, when the close operation is performed, the event and time are acquired. Since the information processing device 30 notifies that the windows of the vehicle 10 have been forgotten to be closed, there is no need to notify when the windows are not open. Therefore, as a precondition, when it is determined that all the windows of vehicle 10 are closed, no notification regarding the windows is made to mobile terminal 20, and the process ends. On the other hand, if it is determined that at least one window of the vehicle 10 is open, then a determination is made as to whether one or more conditions for window notification are met.

### First Condition

The control unit 33 determines whether the first condition that the opening degree of the window acquired in S100 is equal to or greater than the first threshold is satisfied.

Specifically, when the opening degree of the window is less than the first threshold, there is a high probability that the user of the vehicle 10 intentionally opens the window slightly for the purpose of ventilation in the vehicle cabin when the vehicle 10 is stopped. When such an operation of the vehicle 10 is intentionally performed, it is desirable not to notify the mobile terminal 20 of the window because it may become a troublesome notification to notify the operation forgetting of the operation to close the window. On the other hand, if the degree of opening of the window is greater than or equal to the first threshold, it is assumed that the user has forgotten to close the window. Therefore, it is desirable that notification about the window is sent to the mobile terminal 20.

For example, if the vehicle 10 is equipped with a door visor, the first threshold may be an opening degree that does not allow rain to blow into the vehicle cabin even if it rains. Moreover, from the viewpoint of crime prevention, it is sufficient that it is possible to prevent others from accessing the vehicle cabin. Thus, the first threshold can be set arbitrarily. The change of the first threshold value may be set by operating the information processing device 30, for example. Moreover, the change of the first threshold value may be performed by transmitting a command requesting change of the first threshold value from the mobile terminal 20 to the information processing device 30 and changing the first threshold value in accordance with the command.

### Second Condition

The control unit 33 determines whether the second condition that the outside temperature of the vehicle state acquired in S100 is less than the second threshold is satisfied.

Specifically, when the outside temperature is equal to or higher than the second threshold (that is, when the outside temperature is relatively high), the user intentionally opens the window in order to prevent hot air from filling the inside of the vehicle. There is a high probability that the vehicle cabin is being ventilated. When such an operation of the vehicle 10 is intentionally performed, it is desirable not to notify the mobile terminal 20 of the window because it may become a troublesome notification to notify the operation forgetting of the operation to close the window. On the other hand, if the outside temperature is less than the second threshold (that is, if the outside temperature is relatively low), it is assumed that the user has forgotten to close the window. Therefore, it is desirable that notification about the window is sent to the mobile terminal 20.

### Third Condition

The control unit 33 determines whether the third condition that the weather of the vehicle state acquired in S100 is rain or snow is satisfied.

Specifically, when the weather is rain or snow, it is desirable to notify the mobile terminal 20 of the window because rain or snow may blow into the vehicle cabin.

### Fourth Condition

Among the vehicle states acquired in S100, the control unit 33 compares the occurrence time of the event that the vehicle 10 stops with the occurrence time of the event that the open/closed state of the window is less than the first threshold. Then, it is determined whether the difference between the two times is equal to or greater than the third threshold.

Specifically, when the difference between the two times is less than the third threshold (that is, when the difference between the two times is relatively small), the window is opened immediately before the vehicle 10 stops or immediately after the vehicle 10 stops. It means that the opening operation was performed, and it is highly probable that the user intentionally operated the window to ventilate the vehicle cabin. In such a case, it is preferable not to notify the mobile terminal 20 of the window because it may become a troublesome notification to give the operation forgetting notification of the operation to close the window. On the other hand, when the time at which the window opening operation is performed is, for example, before the stop time of the vehicle 10 by the third threshold or more, it is assumed that the user has forgotten to close the window. It is desirable to notify the mobile terminal 20 about the window.

### Fifth Condition

The control unit 33 determines whether the number of windows whose open/closed state is open obtained in S100 is less than the fourth threshold.

Specifically, when the number of windows in the open state is equal to or greater than the fourth threshold (that is, when the number of windows in the open state is relatively large), the user needs to There is a high probability that many windows are intentionally opened to ventilate the vehicle cabin. When such an operation of the vehicle 10 is intentionally performed, it is desirable not to notify the mobile terminal 20 of the window because it may become a troublesome notification to notify the operation forgetting of the operation to close the window. On the other hand, if the number of open windows is less than the fourth threshold (that is, if the number of open windows is relatively small), it is assumed that the user has forgotten to close the windows. Therefore, it is desirable to notify the mobile terminal 20 of the window.

### S130

The control unit 33 determines whether the distance between the vehicle 10 and the mobile terminal 20 is equal to or greater than a specified value. If it is determined that the distance is equal to or greater than the specified value (S130—Yes), the process proceeds to S140. On the other hand, if it is determined that the distance is less than the specified value (S130—No), the process repeats S130.

Specifically, first, the control unit 33 acquires the location information of the mobile terminal 20 that the mobile terminal 20 acquires by the positioning unit 21 from the mobile terminal 20 via the network 40.

Next, the control unit 33 compares the stop position of the vehicle 10 acquired in S100 when the event of stopping the vehicle 10 occurred and the position of the mobile terminal 20, and determines whether the distance between the two is equal to or greater than a specified value.

If the distance between the two is less than a specified value (that is, if the position of the mobile terminal 20 is relatively close to the stop position of the vehicle 10), for example, the user of the vehicle 10 is still inside the vehicle cabin, or the user has left the vehicle 10. There is a high probability that it will be near the vehicle 10 immediately after. In such a situation, it is desirable not to notify the mobile terminal 20 of the window-related notification because it would be a troublesome notification to notify that the operation of closing the window has been forgotten.

### S140

The control unit 33 notifies the mobile terminal 20 of the window.

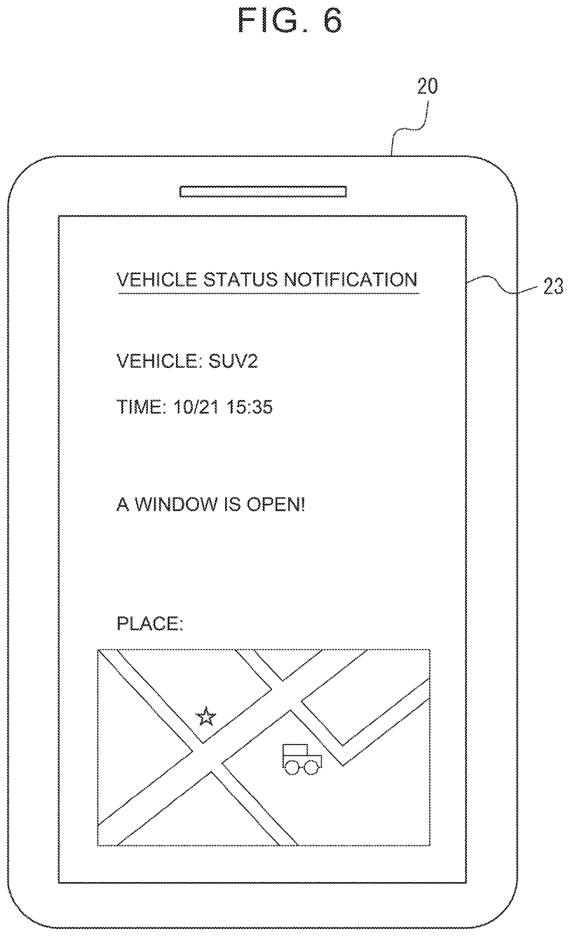

The notification regarding the window includes, for example, information for notifying the user of forgetting to close the window. FIG. 6 shows an example of a specific form of notification. As shown in FIG. 6, the notification of the operation forgetting to close the window displays a warning such as “The window is open!” on the output unit 23 of the mobile terminal 20. At that time, the notification is displayed together with the target vehicle and notification time. The notification may also display the stop position of the vehicle 10 and the position of the mobile terminal 20 on the map. However, notifications regarding windows are not limited to this example. For example, the control unit 33 may transmit an instruction to the vehicle 10 to close all windows. In such a case, the window notification will contain information notifying the user that all windows have been automatically closed (e.g., “We have closed all windows because we detected that you forgot to close a window.” message).

As described above, the information processing device 30 according to the present embodiment performs notification about the window to the mobile terminal 20, when one or more conditions including at least the first condition that the opening degree of the window is equal to or greater than the first threshold when the vehicle 10 is stopped, are satisfied.

According to this configuration, as described above, when there is a high probability that the user intentionally keeps the window open, the notification regarding the window is not performed, and the annoyance of the notification is reduced. Therefore, the technology for notification of forgotten operations of the vehicle 10 is improved.

In the above-described embodiment, the first threshold is changeable as appropriate. However, the control unit 33 of the information processing device 30 may change the first threshold based on the stopped position of the vehicle 10. For example, when the parking position is the garage of the home, it is considered that the security risk is low. On the other hand, if the parking position is a commercial facility or a parking lot in a downtown area, the security station is highly dangerous. Therefore, the first threshold when the stop position is the home can be made larger than the first threshold when the stop position is a commercial facility or a parking lot in a downtown area.

Although the present disclosure has been described above based on the drawings and the embodiments, it should be noted that those skilled in the art may make various modifications and alterations thereto based on the present disclosure. It should be noted, therefore, that these modifications and alterations are within the scope of the present disclosure. For example, the functions included in the configurations, steps, etc. can be rearranged so as not to be logically inconsistent, and a plurality of configurations, steps, etc. can be combined into one or divided.

For example, in the above-described embodiment, an embodiment is also possible in which the configuration and operation of the information processing device 30 are distributed to a plurality of computers that can communicate with each other. Further, for example, an embodiment in which some or all of the components of the information processing device 30 are provided in the vehicle 10 is also possible.

For example, in the above-described embodiment, the mobile terminal 20 is a mobile computer such as a smart phone or a tablet terminal, but it may be a dedicated receiver for receiving the operation forgetting notification.

In the above-described embodiment, an example of a specific notification mode as shown in FIG. 6 has been shown. However, the number of windows in the open state, the position (driver's seat side, passenger seat side, etc.), and the opening degree may be displayed. The mode of notification may be a mode of outputting a warning sound or a warning voice from the voice output unit provided in the mobile terminal 20. Also, the state of outside temperature, rainfall, and snowfall acquired by the vehicle 10 may be notified to the mobile terminal 20.

Further, an embodiment is also possible in which, for example, a general-purpose computer functions as the information processing device 30 according to the above-described embodiment. Specifically, a program describing processing details for realizing each function of the information processing device 30 according to the above-described embodiment is stored in the memory of a general-purpose computer, and the program is read and executed by the processor. Therefore, the present disclosure can also be realized as a program that can be executed by the processor or a non-transitory computer-readable medium that stores the program.

What is claimed is:

1. An information processing device, comprising:
a communication unit that communicates with a mobile terminal owned by a user of a vehicle; and
a control unit that, based on a vehicle state including at least an opening degree of a window of the vehicle, when the vehicle is stopped, performs notification to the mobile terminal regarding the window, wherein the control unit performs the notification to the mobile terminal when one or more conditions, including at least a first condition that the opening degree of the window is no less than a first threshold value, are satisfied.

2. The information processing device according to claim 1, wherein the control unit changes the first threshold value in accordance with an operation performed with respect to the device itself, or a request from the mobile terminal.

3. The information processing device according to claim 1, wherein:
the vehicle state further includes an outside air temperature at a stopped position of the vehicle; and
the one or more conditions further include a second condition that the outside air temperature at the stopped position of the vehicle is lower than a second threshold value.

4. The information processing device according to claim 1, wherein:
the vehicle state further includes weather at a stopped position of the vehicle; and
the one or more conditions further include a third condition that the weather at the stopped position of the vehicle is rain or snow.

5. The information processing device according to claim 1, wherein the control unit changes the first threshold value based on a stopped position of the vehicle.
